(19) United States
(12) Patent Application Publication
(10) Pub. No.: US 2026/0249766 A1
(43) Pub. Date: Aug. 27, 2026

(54) RAMP APPARATUS FOR VEHICLE

(71) Applicants: Kia Corporation, Seoul (KR); Hyundai Motor Company, Seoul (KR)

(72) Inventors: Jung Ho Han, Hwaseong-si (KR); Seong Cheol Park, Hwaseong-si (KR); Do Hee Kim, Hwaseong-si (KR)

(21) Appl. No.: 19/462,481

(22) Filed: Jan. 28, 2026

(30) Foreign Application Priority Data
Feb. 21, 2025 (KR) 10-2025-0023011
Sep. 12, 2025 (KR) 10-2025-0130735

(51) Int. Cl. B60P 1/43; A61G 3/06

(52) U.S. Cl. CPC B60P 1/431; A61G 3/061; A61G 3/067

(57) ABSTRACT

A ramp apparatus for a vehicle may include a housing including a storage space and an opening communicating with the storage space, a step assembly configured to be retracted into or deployed from the storage space of the housing, and including a first step and a second step configured to move relative to the first step, and a link mechanism pivotably coupled between the first step and the second step, wherein the link mechanism may include a pair of first links pivotably connected to the first step, and a second link pivotably connected to the second step, wherein the second link is pivotably connected to the pair of first links.

### CROSS-REFERENCE TO RELATED APPLICATIONS

This application is based on and claims the benefit of priority to Korean Patent Application No. 10-2025-0023011, filed on February 21, 2025 and Korean Patent Application No. 10-2025-0130735, filed on September 12, 2025, in the Korean Intellectual Property Office, the contents of which are incorporated herein in their entirety by reference.

### TECHNICAL FIELD

The present disclosure relates to a ramp apparatus for a vehicle.

### BACKGROUND

Buses or wheelchair accessible vehicles for people with disabilities may include a ramp apparatus that facilitates wheelchair access. The ramp apparatus may include a step stored in a floor of a vehicle body, and the step may be configured to be manually or automatically deployed by a user from the vehicle body to the ground such that the deployed step may be inclined at a predetermined angle with respect to the ground.

In rear-entry vehicles in which the ramp apparatus is mounted at the rear of the vehicle, the ride comfort and noise level experienced by mobility-impaired passengers may be relatively poor. Conventional foldable ramp apparatuses have required the ramp to be deployed even when used by general passengers other than mobility-impaired passengers. Conventional detachable ramp apparatuses have required a separate storage space, and have involved significant preparation time for installation.

The above information described in this background section is provided to assist in understanding the background of the present disclosure, and may include technical concepts that are not considered as the prior art that is already publicly known, available, or in use.

### SUMMARY

The present disclosure relates to a ramp apparatus for a vehicle, and more particularly, to a ramp apparatus for a vehicle that can be easily mounted at various positions of the vehicle due to its compact structure, thereby improving passenger convenience.

Embodiments of the present disclosure may solve the above-mentioned problems occurring in the prior art while advantages achieved by the prior art may be maintained intact.

Some embodiments of the present disclosure may provide a ramp apparatus for a vehicle having a compact structure, thereby being easily mounted at various positions of the vehicle, and improving passenger convenience.

According to an embodiments of the present disclosure, a ramp apparatus for a vehicle may include: a housing including a storage space and an opening communicating with the storage space; a step assembly configured to be retracted into or deployed from the storage space of the housing, and including a first step and a second step configured to move relative to the first step; and a link mechanism including a pair of first links pivotably connected to the first step, and a second link pivotably connected to the second step. The second link may be pivotably connected to the pair of first links.

Each first link may be configured to move between a folded position in which the first link is folded against the second step and an unfolded position in which the first link is unfolded from the second step.

The link mechanism may further include a first biasing member configured to bias each first link toward the folded position.

The second link may be configured to move between a folded position in which the second link is folded against the second step and an unfolded position in which the second link is unfolded from the second step.

The link mechanism may further include a second biasing member configured to bias the second link toward the folded position.

Each first link may include an outer end facing the outside of the vehicle and an inner end facing the inside of the vehicle. The second link may include an outer end facing the outside of the vehicle and an inner end facing the inside of the vehicle. The outer end of each first link may be pivotably connected to the first step through a pivot pin, and the inner end of the second link may be pivotably connected to the second step through a pivot pin.

The outer end of the second link may be aligned with the inner end of each first link, and the outer end of the second link may be pivotably connected to the inner end of each first link through a pivot pin.

Each first link may include an outer end facing the outside of the vehicle and an inner end facing the inside of the vehicle. The second link may include an outer end facing the outside of the vehicle and an inner end facing the inside of the vehicle. The inner end of each first link may be pivotably connected to the first step through a pivot pin, and the inner end of the second link may be pivotably connected to the second step through a pivot pin.

The outer end of the second link may be aligned with the outer end of each first link, and the outer end of the second link may be pivotably connected to the outer end of each first link through a pivot pin.

The step assembly may further include a carriage pivotably connected to the first step, and the carriage may be configured to move within the housing.

The ramp apparatus may further include a cover assembly mounted at the opening of the housing. The cover assembly may include a fixed cover fixed to the housing, and a moving cover pivotably connected to the fixed cover. The moving cover may be configured to move between a cover position in which the moving cover covers the opening of the housing and an uncover position in which the moving cover uncovers the opening of the housing.

The first step may include a first center member extending along a center line thereof, a pair of first side members extending along both side edges thereof, respectively, and a pair of first step plates connected between the first center member and the pair of first side members. The first center member and the pair of first side members may be configured to guide a movement of the second step.

The second step may include a second center member extending along a center line thereof, a pair of second side members extending along both side edges thereof, respectively, and a pair of second step plates connected between the second center member and the pair of second side members. The second center member may be guided along the first center member, and the pair of second side members may be guided along the pair of first side members.

The first center member may have a guide projection protruding toward the second center member, the second center member may have a guide groove in which the guide projection is received, and a movement of the second center member may be guided by the guide projection and the guide groove.

The guide projection may have a T-shaped cross section, and the guide groove may have a T-shaped cross section corresponding to that of the guide projection.

Each first side member may have a cavity in which a corresponding second side member is received, and the second side member may be configured to move in the cavity of the first side member.

### BRIEF DESCRIPTION OF THE DRAWINGS

The above and other features and advantages of some example embodiments of the present disclosure will be more apparent from the following detailed description taken in conjunction with the accompanying drawings, in which:

FIG. 1 illustrates a ramp apparatus for a vehicle according to an example embodiment of the present disclosure, which is disposed on a bottom of the vehicle adjacent to a side opening, with a step assembly stored in a housing;

FIG. 2 illustrates a state in which a step assembly is deployed from a storage space of a housing in a ramp apparatus for a vehicle according to an example embodiment of the present disclosure;

FIG. 3 illustrates a state in which a second step is extended from a first step with a step assembly positioned outside a housing in a ramp apparatus for a vehicle according to an example embodiment of the present disclosure;

FIG. 4 illustrates a perspective view of a ramp apparatus for a vehicle according to an example embodiment of the present disclosure;

FIG. 5 illustrates an exploded perspective view of a housing, a step assembly, and a cover assembly in a ramp apparatus for a vehicle according to an example embodiment of the present disclosure;

FIG. 6 illustrates a cross-sectional view, taken along line A-A of FIG. 4;

FIG. 7 illustrates a cross-sectional view, taken along line B-B of FIG. 6;

FIG. 8 illustrates a perspective view of a housing in a ramp apparatus for a vehicle according to an example embodiment of the present disclosure;

FIG. 9 illustrates an exploded perspective view of first and second covers, a housing, and a carriage in a ramp apparatus for a vehicle according to an example embodiment of the present disclosure;

FIG. 10 illustrates a perspective view of a housing in a ramp apparatus for a vehicle according to an example embodiment of the present disclosure, from which a first cover is removed;

FIG. 11 illustrates a cross-sectional view, taken along line C-C of FIG. 10;

FIG. 12 illustrates a cross-sectional view of a state in which a roller of a carriage is mounted in a rail of a housing in a ramp apparatus for a vehicle according to an example embodiment of the present disclosure;

FIG. 13 illustrates a partially cut-away perspective view of a state in which rollers of a carriage are disposed in a rail of a side member of a housing in a ramp apparatus for a vehicle according to an example embodiment of the present disclosure;

FIG. 14 illustrates a perspective view of a step assembly in a ramp apparatus for a vehicle according to an example embodiment of the present disclosure;

FIG. 15 illustrates a cross-sectional view, taken along line D-D of FIG. 14;

FIG. 16 illustrates a perspective view of pivot connection of a first side member and a side guard in a step assembly of a ramp apparatus for a vehicle according to an example embodiment of the present disclosure;

FIG. 17 illustrates a cross-sectional view, taken along line E-E of FIG. 16;

FIG. 18 illustrates an exploded perspective view of a first step, a second step, and a link mechanism in a step assembly of a ramp apparatus for a vehicle according to an example embodiment of the present disclosure;

FIG. 19 illustrates a bottom view of a ramp apparatus for a vehicle according to an example embodiment of the present disclosure;

FIG. 20 illustrates a state in which first links of a link mechanism are pivotably connected to an inner cross member of a first step in a ramp apparatus for a vehicle according to an example embodiment of the present disclosure;

FIG. 21 illustrates a state in which a second link of a link mechanism is pivotably connected to a second step through a mounting bracket in a ramp apparatus for a vehicle according to an example embodiment of the present disclosure;

FIG. 22 illustrates a mounting bracket configured to be fixed to a second step in a ramp apparatus for a vehicle according to an example embodiment of the present disclosure;

FIG. 23 illustrates a perspective view of a state in which a step assembly is retracted in a storage space of a housing in a ramp apparatus for a vehicle according to an example embodiment of the present disclosure;

FIG. 24 illustrates an extension process in which a second step is first extended from a first step with a step assembly positioned outside a housing in a ramp apparatus for a vehicle according to an example embodiment of the present disclosure;

FIG. 25 illustrates an extension process in which a second step is subsequently extended from a first step with a step assembly positioned outside a housing in a ramp apparatus for a vehicle according to an example embodiment of the present disclosure;

FIG. 26 illustrates an extension process in which a second step is fully extended from a first step with a step assembly positioned outside a housing in a ramp apparatus for a vehicle according to an example embodiment of the present disclosure;

FIG. 27 illustrates a retraction process in which a second step is retracted onto a first step with a step assembly positioned outside a housing in a ramp apparatus for a vehicle according to an example embodiment of the present disclosure;

FIG. 28 illustrates a state in which a second step is fully retracted in a first step with a step assembly positioned outside a housing in a ramp apparatus for a vehicle according to another example embodiment of the present disclosure; and

FIG. 29 illustrates a state in which a second step is partially extended from a first step with a step assembly positioned outside a housing in a ramp apparatus for a vehicle according to another example embodiment of the present disclosure.

### DETAILED DESCRIPTION OF ILLUSTRATIVE EMBODIMENTS

Hereinafter, example embodiments of the present disclosure will be described in detail with reference to the accompanying drawings. In the drawings, same reference numerals may be used throughout to designate same or equivalent elements. A detailed description of well-known techniques associated with the present disclosure may be ruled out in order not to unnecessarily obscure the gist of the present disclosure.

Terms such as first, second, A, B, (a), and (b) may be used to describe the elements in example embodiments of the present disclosure. Such terms may be used merely to distinguish one element from another element, and the intrinsic features, sequence or order, and the like of the corresponding elements are not necessarily limited by such terms. Unless otherwise defined, terms used herein, including technical or scientific terms, may have same meanings as those generally understood by those with ordinary knowledge in the field of art to which the present disclosure belongs. Such terms as those defined in a generally used dictionary may be interpreted as having meanings equal to the contextual meanings in the relevant field of art.

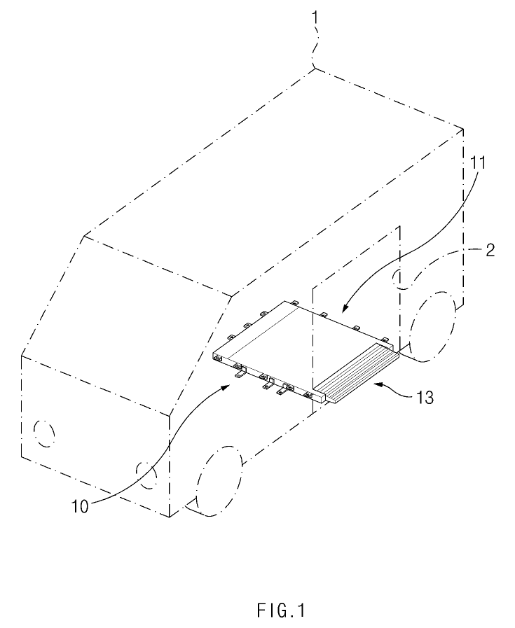

A ramp apparatus 10 for a vehicle according to an example embodiment of the present disclosure may be disposed at various positions of the vehicle. Referring to FIGS. 1 to 3, the ramp apparatus 10 for a vehicle may be disposed on the bottom of the vehicle adjacent to a side opening 2 of the vehicle.

The ramp apparatus 10 for a vehicle according to an example embodiment of the present disclosure may include a housing 11 fixedly mounted to the bottom of the vehicle 1, and a step assembly 12 configured to be deployed from and retracted into the housing 11.

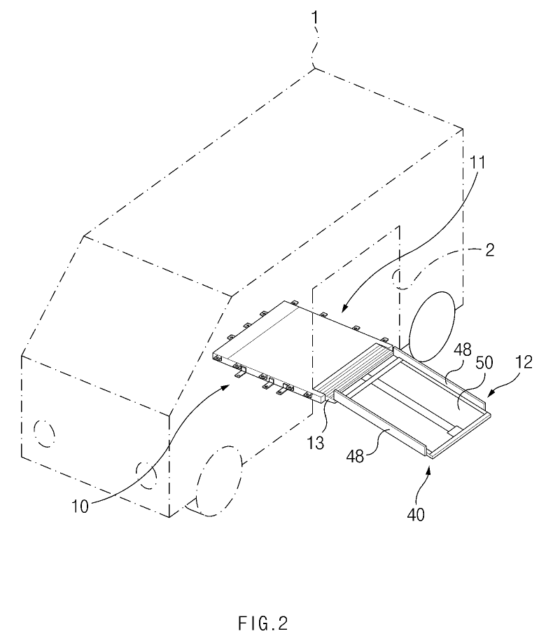

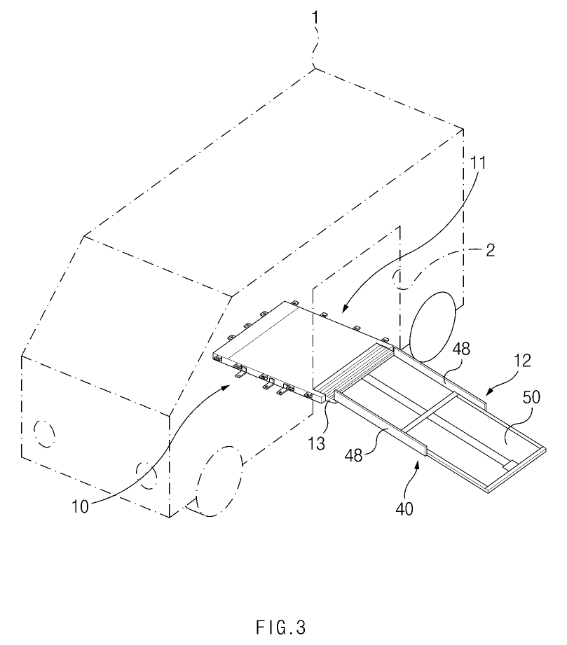

FIG. 1 illustrates a state in which the step assembly 12 is fully stored in the housing 11. FIG. 2 illustrates a state in which the step assembly 12 is deployed from the housing 11, and a second step 50 is retracted in a first step 40. FIG. 3 illustrates a state in which the step assembly 12 is deployed from the housing 11, and the second step 50 is extended from the first step 40.

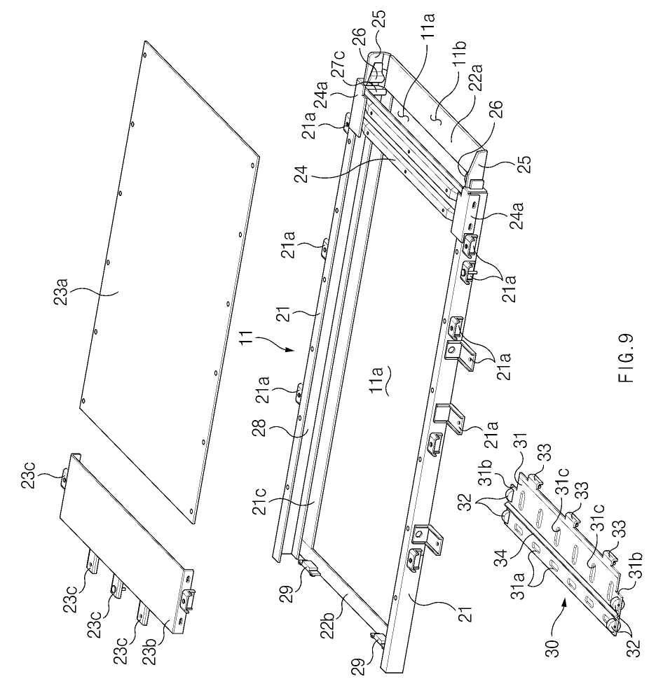

The housing 11 may include an outer edge facing the outside of the vehicle, and an inner edge located inside the vehicle. Referring to FIG. 9, the housing 11 may include a storage space 11a defined therein, and an opening 11b communicating with the storage space 11a. The opening 11b may be provided in the outer edge of the housing 11, and the opening 11b may face the outside of the vehicle. The housing 11 may include a pair of side members 21 spaced apart from each other. Each side member 21 may include an outer end facing the outside of the vehicle, and an inner end facing the inside of the vehicle. The pair of side members 21 may be spaced apart from each other by a distance greater than a width of the step assembly 12, and the pair of side members 21 may define the storage space 11a in which the step assembly 12 is stored. Each side member 21 may be mounted on the bottom of the vehicle 1 through a plurality of brackets 21a. Referring to FIG. 9, each side member 21 may have a support plate 21c provided on a bottom surface thereof, and the support plate 21c may partially cover a bottom surface of the storage space 11a. The support plate 21c may extend along a longitudinal direction of the side member 21.

Referring to FIG. 9, the housing 11 may include an outer cross member 22a connecting the outer ends of the side members 21, and an inner cross member 22b connecting the inner ends of the side members 21. The outer cross member 22a may extend along the outer edge of the housing 11, and the outer cross member 22a may connect the bottom surfaces of the side members 21. The inner cross member 22b may extend along the inner edge of the housing 11, and the inner cross member 22b may connect the bottom surfaces of the side members 21. The outer cross member 22a and the inner cross member 22b may extend along a width direction of the housing 11.

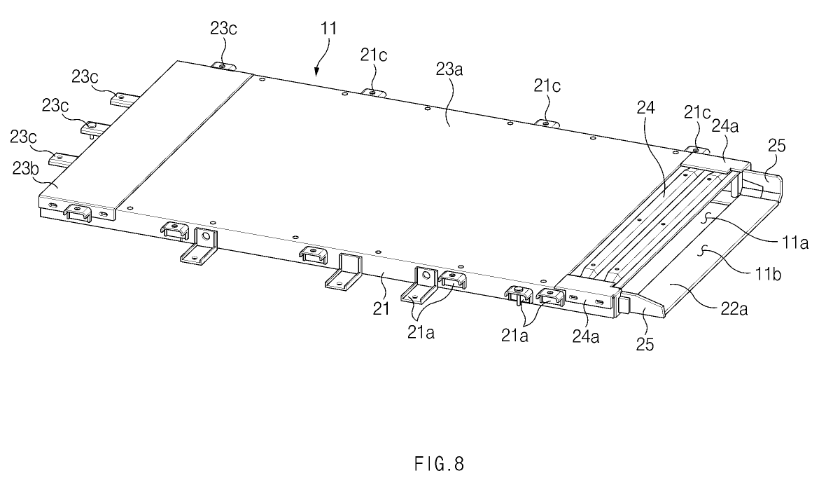

Referring to FIGS. 8 and 9, the housing 11 may include a reinforcing member 24 provided at the outer edge thereof. The reinforcing member 24 may connect the pair of side members 21 in the width direction of the housing 11, and the reinforcing member 24 may extend along the width direction of the housing 11. Both ends of the reinforcing member 24 may be mounted on top surfaces of the outer ends of the pair of side members 21 through a pair of brackets 24a. The reinforcing member 24 may be parallel to the outer cross member 22a, and the reinforcing member 24 may be located above the outer cross member 22a.

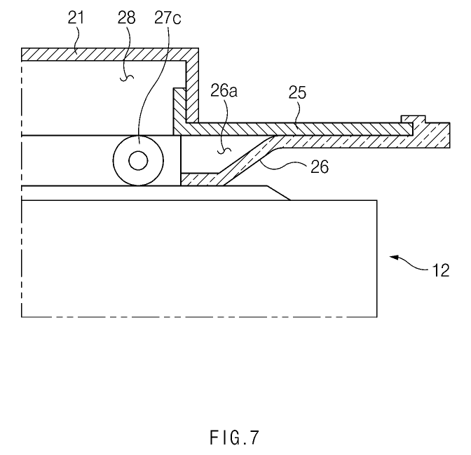

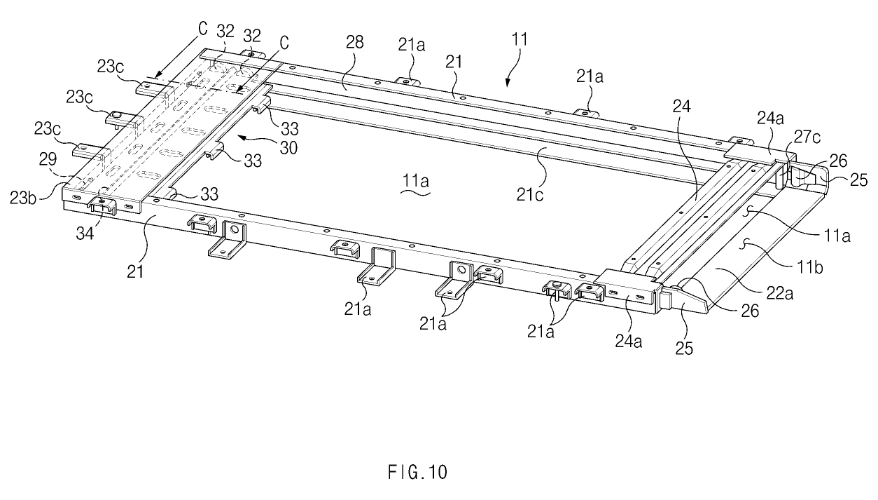

Referring to FIGS. 9 and 10, the housing 11 may include a pair of side guides 26 disposed at both sides of the opening 11b. A pair of end pieces 25 may be fixed to both ends of the outer cross member 22a, and the pair of side guides 26 may be mounted on the pair of end pieces 25, respectively. When the step assembly 12 is retracted into the storage space 11a of the housing 11, the pair of side guides 26 may guide both side edges of the step assembly 12, and prevent the step assembly 12 from moving in a lateral direction. Referring to FIG. 7, each side guide 26 may have a cavity 26a defined therein.

Referring to FIGS. 7 and 10, the housing 11 may include a pair of side guide rollers 27c rotatably disposed behind the pair of side guides 26. The pair of side guide rollers 27c may guide both side edges of the step assembly 12 during the movement of the step assembly 12.

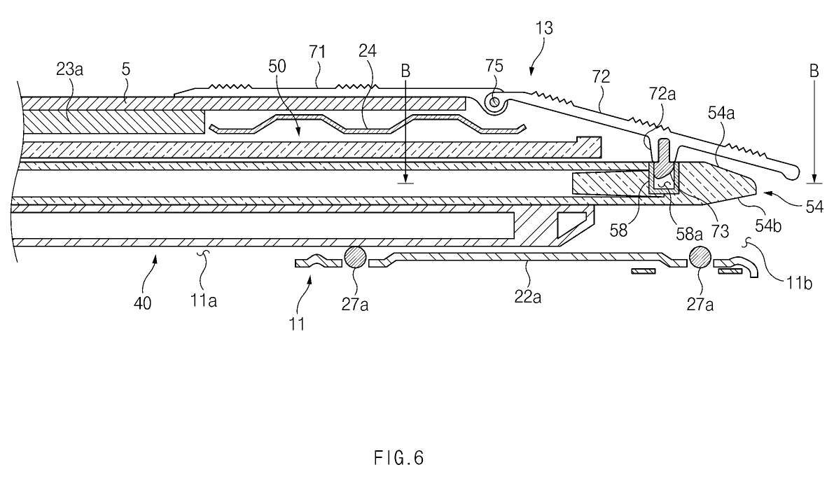

Referring to FIG. 6, the housing 11 may further include one or more lower guide rollers 27a rotatably mounted on the outer cross member 22a. The lower guide rollers 27a may smoothly guide a bottom surface of the step assembly 12 when the step assembly 12 moves relative to the housing 11.

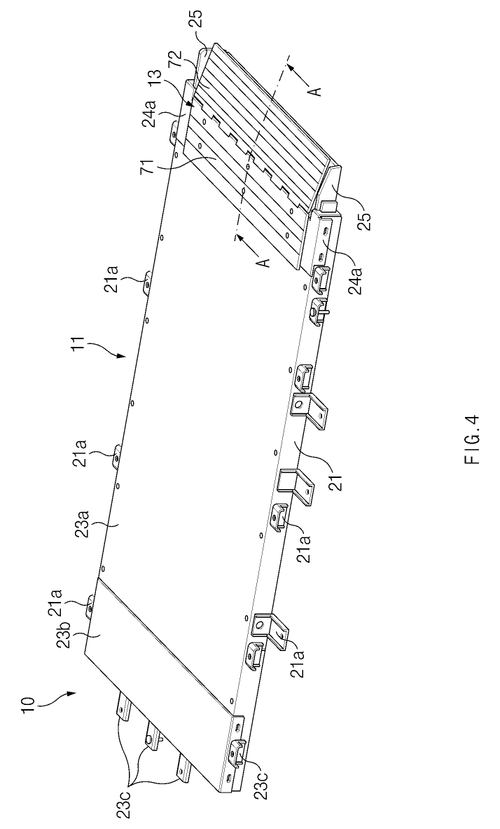

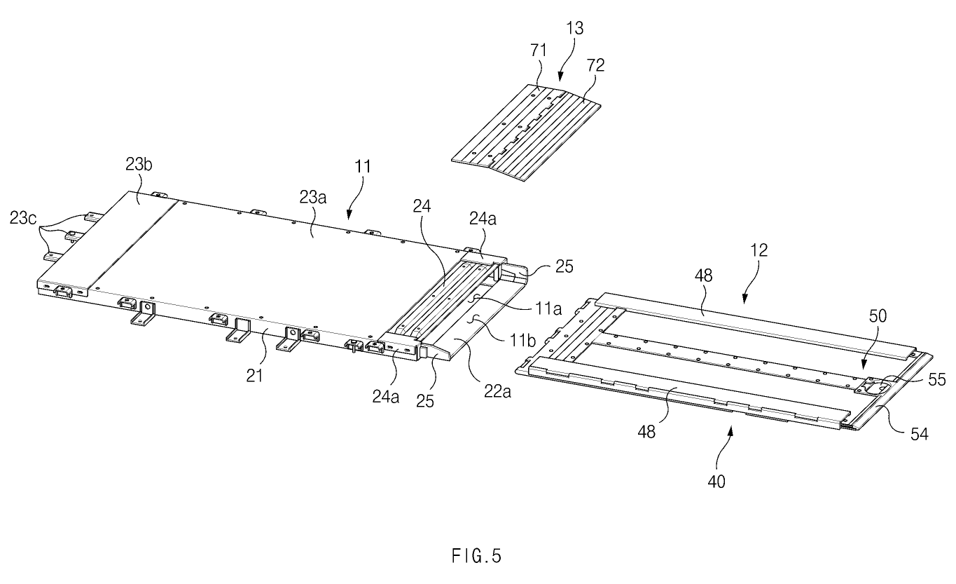

The housing 11 may include a plurality of covers 23a and 23b covering the top of the storage space 11a defined by the pair of side members 21. Referring to FIGS. 4, 5, 8, and 9, the plurality of covers 23a and 23b may include a first cover 23a attached to portions of the side members 21 adjacent to the outer ends of the side members 21 and middle portions of the side members 21, and a second cover 23b attached to portions of the side members 21 adjacent to the inner ends of the side members 21. The first cover 23a may be configured to cover a portion of the storage space 11a defined by the pair of side members 21, which is adjacent to the outer ends of the side members 21 and the middle portions of the side members 21. The second cover 23b may be configured to cover a remaining portion of the storage space 11a defined by the pair of side members 21, which is adjacent to the inner ends of the side members 21. The second cover 23b may be mounted on the bottom of the vehicle 1 through a plurality of brackets 23c. The second cover 23b may be fixed to portions of the side members 21 adjacent to the inner ends of the side members 21 and inner end surfaces of the side members 21. The plurality of covers 23a and 23b may be mounted on the bottom of the vehicle 1, and the plurality of covers 23a and 23b may form a portion of a floor of the vehicle 1.

According to an example embodiment, the first cover 23a may be pivotably connected to the second cover 23b so that the first cover 23a may be opened and closed on the top of the housing 11, and accordingly replacement and maintenance of the step assembly 12 may be facilitated.

The step assembly 12 may include a carriage 30 configured to move within the housing 11, the first step 40 connected to the carriage 30, and the second step 50 movable relative to the first step 40.

Referring to FIGS. 9 and 10, the carriage 30 may include a plate 31, and a plurality of rollers 32 rotatably mounted at both side edges of the plate 31. The plate 31 may have an outer edge facing the outer edge of the housing 11, and an inner edge facing the inner edge of the housing 11. The plate 31 may have a plurality of pivot lugs 33 provided at the outer edge thereof.

Referring to FIGS. 9 to 11, the plate 31 may have a reinforcing bead 34 extending along a width direction thereof, and the reinforcing bead 34 may protrude upward. Accordingly, widthwise stiffness of the plate 31 may be enhanced by the reinforcing bead 34.

Referring to FIG. 9, the plate 31 may have a plurality of first holes 31a and a plurality of second holes 31c separated by the reinforcing bead 34. Accordingly, the weight of the plate 31 may be reduced by the plurality of first holes 31a and the plurality of second holes 31c.

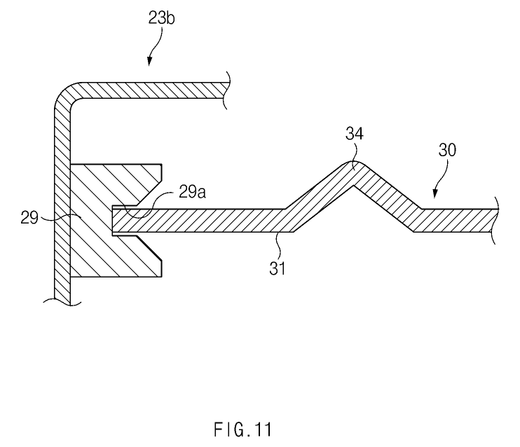

Referring to FIG. 11, the housing 11 may further include a supporter 29 configured to support the inner edge of the plate 31 of the carriage 30 when the step assembly 12 is fully retracted into the storage space 11a of the housing 11. The supporter 29 may be fixed to the second cover 23b, and have a groove 29a in which the inner edge of the plate 31 of the carriage 30 is received. The supporter 29 may be made of a shock-absorbing material such as rubber. Accordingly, as the plate 31 of the carriage 30 is received in the groove 29a of the supporter 29, an impact on the plate 31 of the carriage 30 may be absorbed by the supporter 29, and noise generation may be prevented.

Referring to FIGS. 9 and 10, each side member 21 may include a rail 28 configured to guide the movement of the rollers 32 of the carriage 30. The rail 28 may extend along the longitudinal direction of each side member 21, and the rail 28 of each side member 21 may face the storage space 11a of the housing 11.

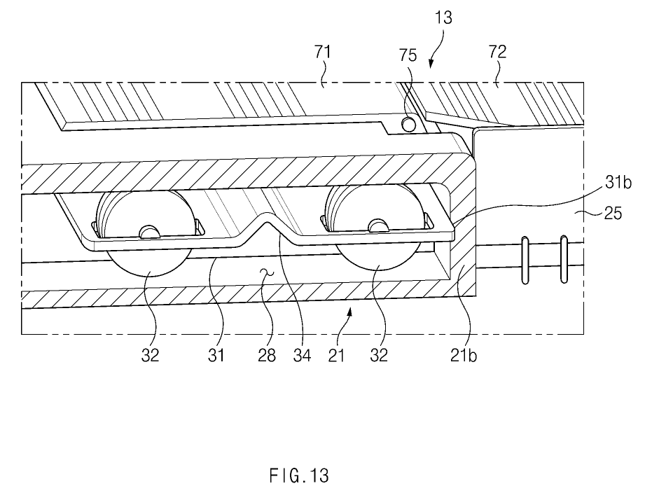

Referring to FIG. 13, the carriage 30 may have a pair of stoppers 31b provided at both sides of the plate 31, respectively, and each side member 21 may have a stopper 21b provided on the outer end thereof. When the step assembly 12 is deployed from the housing 11, each stopper 31b of the carriage 30 may come into contact with the stopper 21b of the corresponding side member 21 of the housing 11, and accordingly the carriage 30 of the step assembly 12 may be prevented from being completely separated from the housing 11.

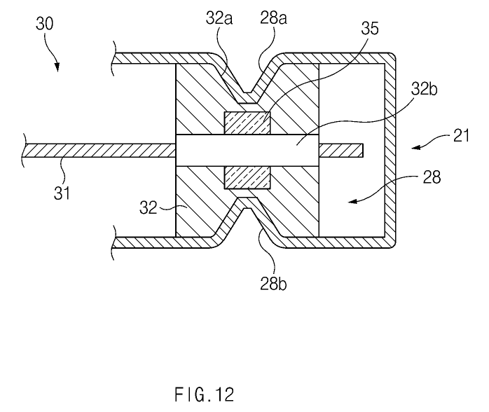

Referring to FIG. 12, the rail 28 may include an upper guide projection 28a provided on a top wall thereof, and a lower guide projection 28b provided on a bottom wall thereof. Each roller 32 may have a guide groove 32a formed in an outer circumferential surface thereof, and the guide groove 32a of each roller 32 may be guided along the upper guide projection 28a and the lower guide projection 28b. A shaft 32b may be provided at the side edge of the plate 31, and each roller 32 may be rotatably supported on the shaft 32b through a bearing 35.

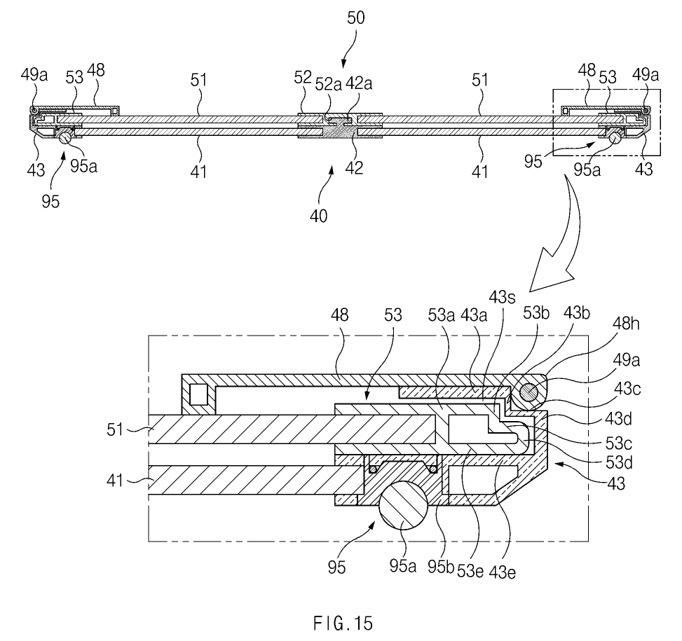

The first step 40 may be configured to guide the movement of the second step 50 at a center portion and both side portions thereof. Referring to FIG. 15, the first step 40 may include a pair of first step plates 41, a first center member 42 connected between the pair of first step plates 41, and a pair of first side members 43 connected to the pair of first step plates 41, respectively.

Each first step plate 41 may have a honeycomb structure, a steel mesh, or the like provided therein, thereby providing stable load support. The pair of first step plates 41 may be connected between the first center member 42 and the pair of first side members 43 so that the first step 40 may uniformly distribute loads.

The first center member 42 may extend along a center line of the first step 40, and the first center member 42 may be made of a material having relatively high stiffness. Accordingly, the first center member 42 may prevent sagging of the center portion of the first step 40. The first center member 42 may be configured to guide the movement (sliding) of the second step 50. Referring to FIG. 15, the first center member 42 may have a guide projection 42a protruding upward from a top surface thereof. The guide projection 42a may extend along a longitudinal direction of the first center member 42. The guide projection 42a may have a T-shaped cross section.

The pair of first side members 43 may extend along both side edges of the first step 40, respectively. Each first side member 43 may be fixed to an edge of the corresponding first step plate 41, and the first side member 43 may be made of a material having relatively high stiffness. Accordingly, the pair of first side members 43 may increase side stiffness of the first step 40.

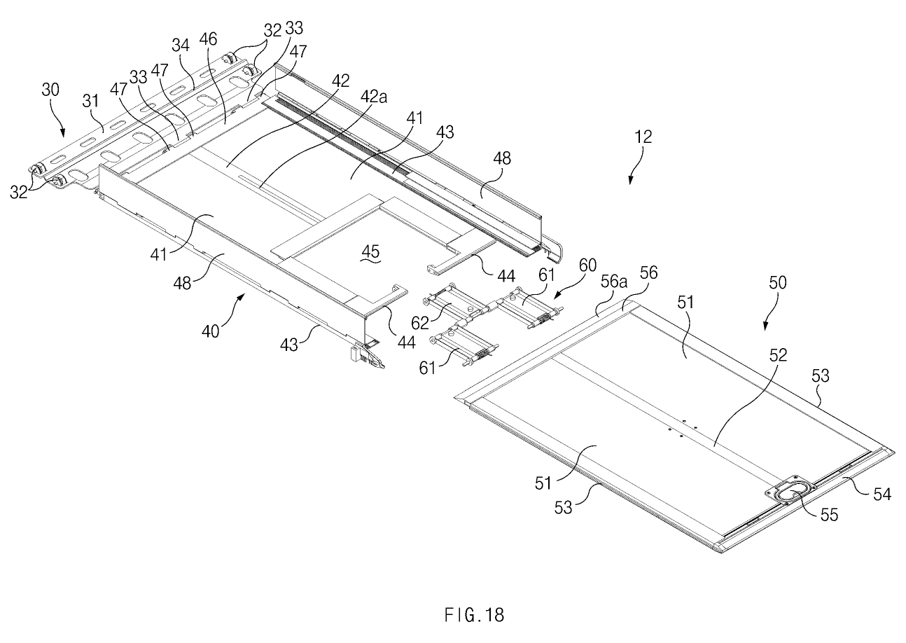

Each first side member 43 may be configured to guide the movement (sliding) of the second step 50. Referring to FIG. 18, a length of each first side member 43 may be greater than that of the first center member 42. Referring to FIG. 15, each first side member 43 may include an upper horizontal wall 43a, an inner vertical wall 43b extending vertically from the upper horizontal wall 43a, an intermediate horizontal wall 43c extending horizontally from the inner vertical wall 43b, an outer vertical wall 43d extending vertically from the intermediate horizontal wall 43c, and a lower horizontal wall 43e extending horizontally from the outer vertical wall 43d. The first side member 43 may have a cavity 43s defined by the upper horizontal wall 43a, the inner vertical wall 43b, the intermediate horizontal wall 43c, the outer vertical wall 43d, and the lower horizontal wall 43e. A second side member 53 of the second step 50 to be described below may be movably received in the cavity 43s of the first side member 43.

The first step 40 may include an outer edge facing the outside of the vehicle 1 and an inner edge facing the inside of the vehicle 1. Referring to FIG. 18, the first step 40 may include an outer cross member 44 provided at the outer edge thereof and an inner cross member 46 provided at the inner edge thereof. The outer cross member 44 and the inner cross member 46 may extend along a width direction of the first step 40. The outer cross member 44 may be fixed to outer edges of the pair of first step plates 41, respectively. The inner cross member 46 may be fixed to inner edges of the pair of first step plates 41 and an inner end of the first center member 42.

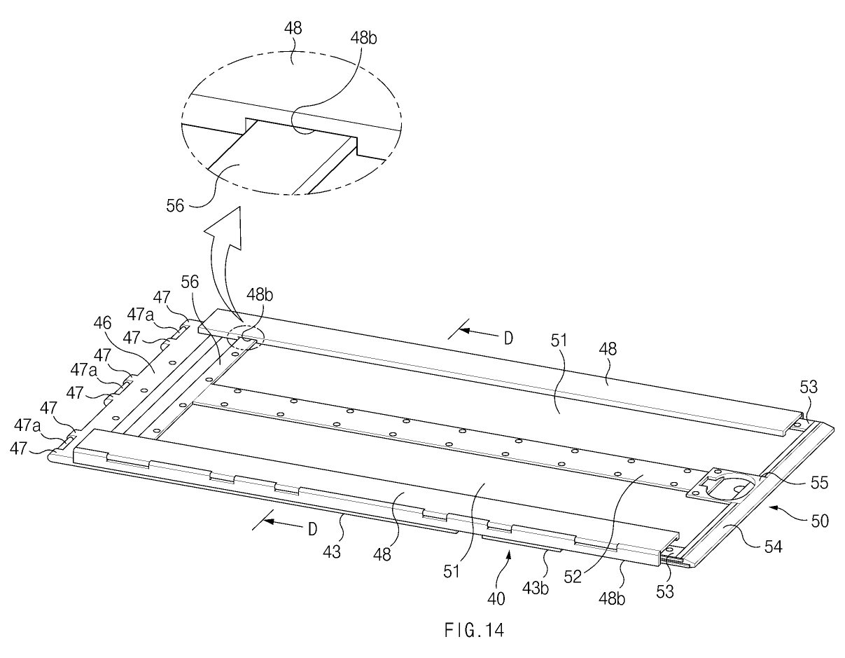

Referring to FIGS. 14 and 18, the first step 40 may have a plurality of pivot lugs 47 provided at the inner edge thereof. The plurality of pivot lugs 47 may protrude from the inner cross member 46 toward the carriage 30. The pivot lugs 47 of the first step 40 may be connected to the pivot lugs 33 of the carriage 30 through pivot pins 47a, respectively.

Referring to FIG. 18, the first step 40 may have an opening 45 adjacent to the outer edge thereof. The opening 45 may be defined by the pair of first step plates 41 and the outer cross member 44. A middle portion of the outer cross member 44 facing the opening 45 may be cut out so that the opening 45 may be open toward the outside of the vehicle.

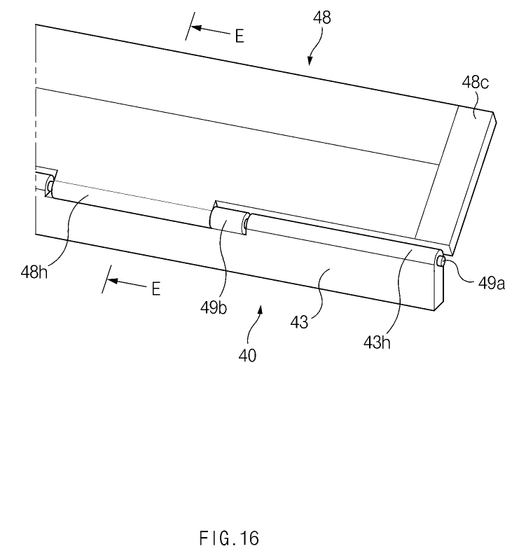

Referring to FIGS. 16 and 18, the first step 40 may include a pair of side guards 48 pivotably connected to the pair of first side members 43, respectively. Each side guard 48 may have a pivot lug 48h protruding toward the corresponding first side member 43, and each first side member 43 may have a pivot lug 43h protruding toward the corresponding side guard 48.

Referring to FIG. 16, as a pivot pin 49a may extend through a hole of the pivot lug 48h of the side guard 48 and a hole of the pivot lug 43h of the first side member 43, each side guard 48 may be pivotably connected to the corresponding first side member 43. Each side guard 48 may be configured to move between a folded position in which the side guard 48 is folded against the first side member 43 of the first step 40 and an unfolded position in which the side guard 48 is unfolded from the first side member 43 of the first step 40 at a predetermined angle. When each side guard 48 is in the folded position, the side guard 48 may be parallel to the first side member 43 of the first step 40. In some embodiments, when each side guard 48 is in the unfolded position, an angle between the side guard 48 and the first side member 43 of the first step 40 may be greater than or equal to 90°. Referring to FIGS. 2 and 3, when the step assembly 12 is deployed from the housing 11, the pair of side guards 48 may move to the unfolded position so that the pair of side guards 48 may prevent users such as wheelchair users or persons with disabilities from falling.

Referring to FIG. 16, the first step 40 may further include a friction member 49b disposed between the pivot lug 48h of the side guard 48 and the pivot lug 43h of the first side member 43. The friction member 49b may be made of a friction material such as rubber, be disposed around the pivot pin 49a, and be in frictional contact with the side guard 48 and the first side member 43. Accordingly, the side guard 48 may be stably maintained in the unfolded position or the folded position by the friction member 49b.

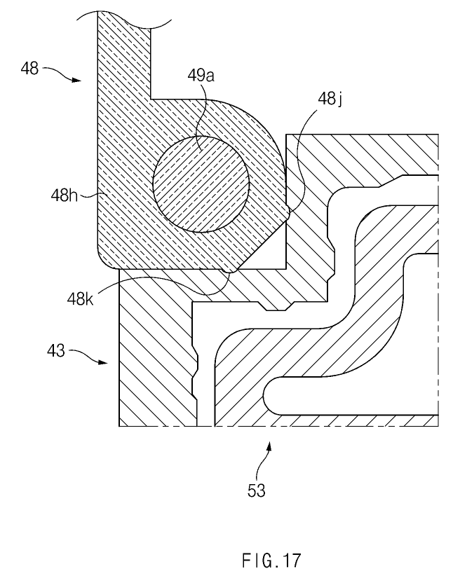

Referring to FIG. 17, the pivot lug 48h of the side guard 48 may include a plurality of contact projections 48j and 48k configured to contact the first side member 43. When the side guard 48 is in the unfolded position, the plurality of contact projections 48j and 48k may be in frictional contact with the first side member 43 so that the side guard 48 may be stably maintained in the unfolded position.

Referring to FIG. 15, in some embodiments, the first step 40 may further include a plurality of ball guides 95 provided on a bottom surface thereof. Each ball guide 95 may include a rotatable ball 95a and a cage 95b that retains the ball 95a. The cage 95b may be mounted on the first side member 43 of the first step 40, and the ball 95a may be rotatably supported in the cage 95b. When the first step 40 moves in the storage space 11a of the housing 11, the first step 40 may smoothly move along the support plates 21c (see FIGS. 9 and 10) of the housing 11 by the plurality of ball guides 95.

The second step 50 may move relative to the first step 40 so that the second step 50 may be extended from the first step 40 or retracted onto the first step 40. Referring to FIGS. 14 and 15, the second step 50 may be retracted in the first step 40 in an overlapping manner.

The second step 50 may be guided by the center portion and both side portions of the first step 40. Referring to FIG. 18, the second step 50 may include a pair of second step plates 51, a second center member 52 connected between the pair of second step plates 51, and a pair of second side members 53 connected to the pair of second step plates 51, respectively.

In some embodiments, each second step plate 51 may have a honeycomb structure, a steel mesh, or the like provided therein, thereby providing stable load support, for example. The pair of second step plates 51 may be connected between the second center member 52 and the pair of second side members 53 so that the second step 50 may uniformly distribute loads. The pair of second step plates 51 may be aligned with the pair of first step plates 41, as illustrated in FIG. 15.

The second center member 52 may extend along a center line of the second step 50, and the second center member 52 may be made of a material having relatively high stiffness. Accordingly, the second center member 52 may prevent sagging of a center portion of the second step 50.

Referring to FIG. 15, the second center member 52 may be aligned with the first center member 42, and the second center member 52 may be guided along the first center member 42. The second center member 52 may have a guide groove 52a in which the guide projection 42a of the first step 40 is received, and the guide groove 52a may extend along a longitudinal direction of the second center member 52. Referring to FIG. 15, the guide groove 52a may have a T-shaped cross section corresponding to the shape and size of the guide projection 42a. Accordingly, the movement of the second step 50 may be guided by the guide projection 42a of the first center member 42 and the guide groove 52a of the second center member 52 so that extension and retraction of the second step 50 may be performed more accurately. In a state in which the second step 50 is extended from the first step 40, support stiffness of the first step 40 and the second step 50 may be enhanced by the first center member 42 and the second center member 52. In particular, in some embodiments, because the guide projection 42a and the guide groove 52a have the corresponding T-shaped cross section, the second step 50 may be prevented from wobbling in vertical and lateral directions during the movement of the second step 50.

The pair of second side members 53 may extend along both side edges of the second step 50, respectively. Each second side member 53 may be fixed to an edge of the corresponding second step plate 51, and the second side member 53 may be made of a material having relatively high stiffness. Accordingly, the pair of second side members 53 may increase side stiffness of the second step 50.

Referring to FIG. 15, each second side member 53 may be configured to move in the cavity 43s of the corresponding first side member 43, and be guided along the corresponding first side member 43. Each second side member 53 may include an upper horizontal wall 53a, an inner vertical wall 53b extending vertically from the upper horizontal wall 53a, an intermediate horizontal wall 53c extending horizontally from the inner vertical wall 53b, an outer vertical wall 53d extending vertically from the intermediate horizontal wall 53c, and a lower horizontal wall 53e extending horizontally from the outer vertical wall 53d.

In some embodiments, when the second step 50 moves (is extended or retracted) relative to the first step 40, the upper horizontal wall 53a of the second side member 53 may be guided along the upper horizontal wall 43a of the first side member 43, the inner vertical wall 53b of the second side member 53 may be guided along the inner vertical wall 43b of the first side member 43, the intermediate horizontal wall 53c of the second side member 53 may be guided along the intermediate horizontal wall 43c of the first side member 43, the outer vertical wall 53d of the second side member 53 may be guided along the outer vertical wall 43d of the first side member 43, and the lower horizontal wall 53e of the second side member 53 may be guided along the lower horizontal wall 43e of the first side member 43. Accordingly, the movement of the second step 50 may be guided by the second side member 53 and the first side member 43 so that extension and retraction of the second step 50 may be performed more accurately. In a state in which the second step 50 is extended from the first step 40, support stiffness of the first step 40 and the second step 50 may be enhanced by the first side member 43 and the second side member 53. In particular, as the upper horizontal wall 53a, the inner vertical wall 53b, the intermediate horizontal wall 53c, the outer vertical wall 53d, and the lower horizontal wall 53e of the second side member 53 are guided along the upper horizontal wall 43a, the inner vertical wall 43b, the intermediate horizontal wall 43c, the outer vertical wall 43d, and the lower horizontal wall 43e of the first side member 43, the second side member 53 may be prevented from wobbling in vertical and lateral directions during the movement of the second side member 53.

The second step 50 may include an outer edge facing the outside of the vehicle 1 and an inner edge facing the inside of the vehicle 1. Referring to FIG. 18, the second step 50 may include an outer cross member 54 provided at the outer edge thereof and an inner cross member 56 provided at the inner edge thereof. The outer cross member 54 and the inner cross member 56 may extend along a width direction of the second step 50, and the outer cross member 54 may be fixed to outer edges of the pair of second step plates 51 and an outer end of the second center member 52. The inner cross member 56 may be fixed to inner edges of the pair of second step plates 51 and an inner end of the second center member 52.

Referring to FIG. 6, the outer cross member 54 may have an upper chamfered surface 54a and a lower chamfered surface 54b. The lower chamfered surface 54b of the outer cross member 54 may tightly contact the ground or a curb, and the upper chamfered surface 54a of the outer cross member 54 may be configured to overcome a height difference between the outer cross member 54 and the ground (or curb).

Referring to FIG. 18, the inner cross member 56 may have a chamfered surface 56a inclined toward the first step 40. In some embodiments, when the second step 50 is extended from the first step 40, the chamfered surface 56a of the inner cross member 56 may be configured overcome a height difference between the first step 40 and the second step 50. In some embodiments, a grip 55 may be disposed adjacent to the outer cross member 54, and the user may use the grip 55 to move the second step 50 relative to the first step 40.

Referring to FIG. 14, each side guard 48 of the first step 40 may further include a retaining recess 48b. In some embodiments, when the second step 50 is fully retracted in the first step 40 and the side guards 48 of the first step 40 are in the folded position, the inner cross member 56 of the second step 50 may be received in the retaining recesses 48b of the side guards 48 of the first step 40. As both ends of the inner cross member 56 of the second step 50 are received in the retaining recesses 48b of the side guards 48 of the first step 40, the second step 50 may be maintained in the retracted state in the first step 40 so that the second step 50 may be prevented from unintended extension from the first step 40.

In some embodiments, the ramp apparatus 10 for a vehicle according to an example embodiment of the present disclosure may further include a cover assembly 13 mounted in the opening 11b of the housing 11. Referring to FIG. 6, the cover assembly 13 may include a fixed cover 71 fixed to the housing 11, and a moving cover 72 pivotably mounted to the fixed cover 71.

The fixed cover 71 may be fixed to the outer edge of the housing 11. The fixed cover 71 may be fixed to the reinforcing member 24 of the housing 11 through a fastener and/or the like, and an outer edge of a carpet 5 may be interposed between the fixed cover 71 and the reinforcing member 24.

The moving cover 72 may be pivotably mounted to the fixed cover 71 through a pivot pin 75. The moving cover 72 may be configured to move between a cover position in which the moving cover 72 covers the opening 11b of the housing 11 and an uncover position in which the moving cover 72 uncovers the opening 11b of the housing 11. When the moving cover 72 is in the uncover position, the step assembly 12 may be deployed from the storage space 11a of the housing 11. After the step assembly 12 is retracted into the storage space 11a of the housing 11, the moving cover 72 may move to the cover position.

Referring to FIG. 6, the moving cover 72 may include a projection 73 protruding downward, and a mounting boss 72a may be provided on a bottom surface of the moving cover 72. The projection 73 may be mounted into the mounting boss 72a.

The outer cross member 54 of the second step 50 may include a channel 58 having a groove 58a that is open upward. In some embodiments, when the step assembly 12 is retracted into the storage space 11a of the housing 11, the projection 73 of the moving cover 72 may be fitted into the groove 58a of the channel 58 of the outer cross member 54 of the second step 50 so that the moving cover 72 may be maintained in the cover position. In some embodiments, because the step assembly 12 is maintained in the retracted state within the storage space 11a of the housing 11, the step assembly 12 may be prevented from unintended deployment from the storage space 11a of the housing 11. In some embodiments, the moving cover 72 may cover the opening 11b of the housing 11 and the outer edge of the step assembly 12, thereby preventing the step assembly 12 from being exposed to the outside.

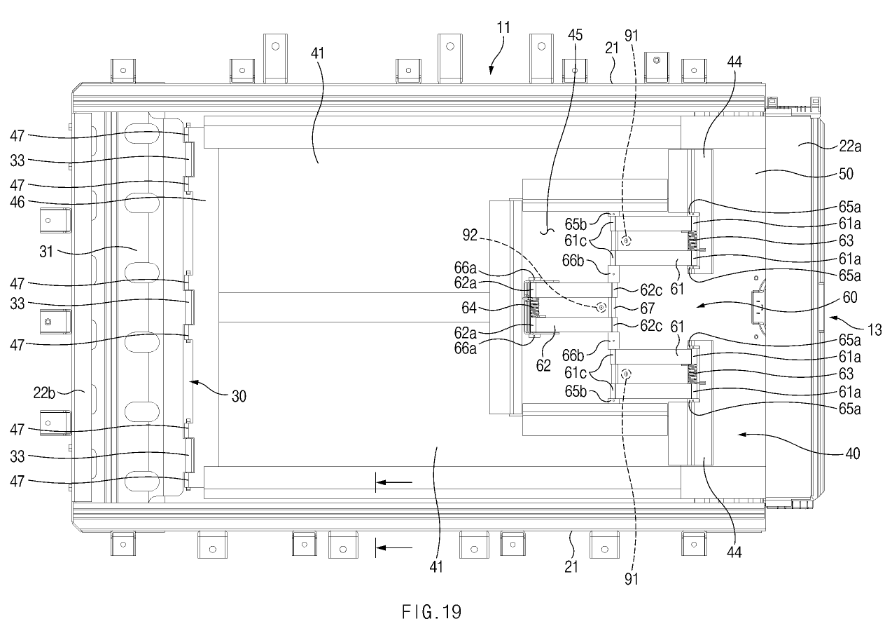

Referring to FIGS. 18 and 19, the ramp apparatus 10 for a vehicle according to an example embodiment of the present disclosure may further include a link mechanism 60 connected between the first step 40 and the second step 50 of the step assembly 12. The link mechanism 60 may be disposed in the opening 45 of the first step 40. The link mechanism 60 may include a pair of first links 61 pivotably connected to the first step 40 and a second link 62 pivotably connected to the second step 50. A length of each first link 61 may be the same as that of the second link 62.

The pair of first links 61 may be pivotably connected to the outer cross member 44 of the first step 40. Each first link 61 may include an outer end facing the outside of the vehicle and an inner end facing the inside of the vehicle.

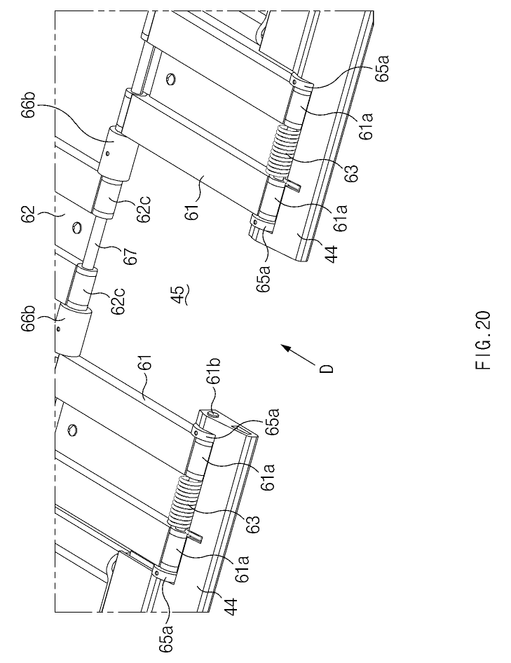

The outer end of each first link 61 may be pivotably connected to the first step 40 through a pivot pin 61b. Referring to FIG. 20, each first link 61 may have a pair of first outer lugs 61a fixed to the outer end thereof. The first outer lugs 61a of each first link 61 may be pivotably connected to the outer cross member 44 through the pivot pin 61b.

Each first link 61 may be configured to move between a folded position in which the first link 61 is folded against the second step 50 and an unfolded position in which the first link 61 is unfolded from the second step 50 toward the ground. When each first link 61 is in the folded position, the first link 61 may be parallel to the first step 40 and the second step 50 and the first link 61 may contact the second step 50. When each first link 61 is in the unfolded position, the first link 61 may be inclined at an angle with respect to the second step 50.

The link mechanism 60 may further include a first biasing member 63 configured to bias each first link 61 toward the folded position. The first biasing member 63 may be a torsion spring mounted around the pivot pin 61b. Each first link 61 may be biased toward the folded position by the first biasing member 63.

Each first link 61 may include a pair of first outer rollers 65a adjacent to the pair of first outer lugs 61a, respectively. The pair of first outer rollers 65a may be rotatably supported by the pivot pin 61b. When the second step 50 moves (is extended or retracted) relative to the first step 40, the first outer rollers 65a of the first link 61 may be in rolling contact with the second step 50.

The second link 62 may be pivotably connected to the second step 50, and the second link 62 may include an outer end facing the outside of the vehicle and an inner end facing the inside of the vehicle.

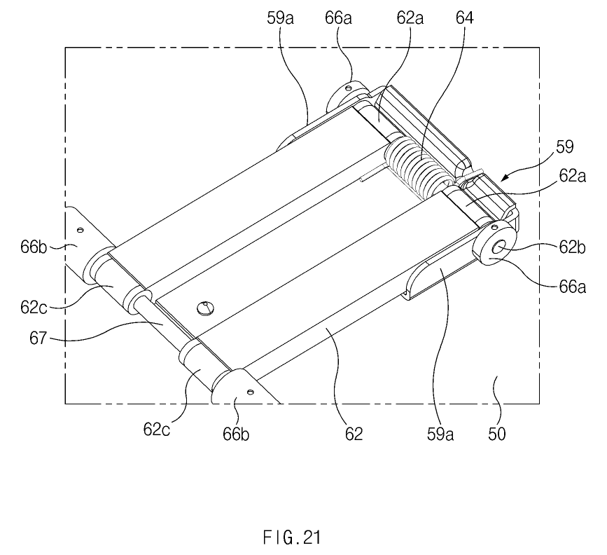

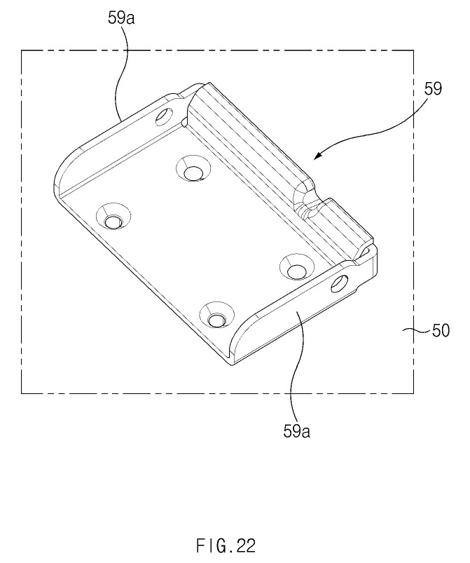

The inner end of the second link 62 may be pivotably connected to the second step 50 through a pivot pin 62b. Referring to FIG. 21, the second link 62 may have a pair of second inner lugs 62a fixed to the inner end thereof. The pair of second inner lugs 62a of the second link 62 may be pivotably connected to the second step 50 through the pivot pin 62b. Referring to FIGS. 21 and 22, a mounting bracket 59 may be fixed to the second step 50. The mounting bracket 59 may have a pair of mounting sidewalls 59a, and the pivot pin 62b may be rotatably supported by the mounting sidewalls 59a of the mounting bracket 59. The pivot pin 61b of the first link 61 may be spaced apart from the pivot pin 62b of the second link 62 in a longitudinal direction of the step assembly 12.

The second link 62 may be configured to move between a folded position in which the second link 62 is folded against the second step 50 and an unfolded position in which the second link 62 is unfolded from the second step 50 toward the ground. When the second link 62 is in the folded position, the second link 62 may be parallel to the second step 50, and the second link 62 may contact the second step 50. When the second link 62 is in the unfolded position, the second link 62 may be inclined at an angle with respect to the second step 50.

The link mechanism 60 may further include a second biasing member 64 configured to bias the second link 62 toward the folded position. The second biasing member 64 may be a torsion spring mounted around the pivot pin 62b. The second link 62 may be biased toward the folded position by the second biasing member 64.

The second link 62 may have a pair of second inner rollers 66a adjacent to the pair of second inner lugs 62a, respectively. The pair of second inner rollers 66a may be rotatably supported by the pivot pin 62b. When the second step 50 moves (is extended or retracted) relative to the first step 40, the second inner rollers 66a of the second link 62 may be in rolling contact with the second step 50.

The outer end of the second link 62 may be aligned with the inner end of each first link 61, and the outer end of the second link 62 may be pivotably connected to the inner end of each first link 61 through a pivot pin 67. Specifically, the second link 62 may have a pair of second outer lugs 62c fixed to the outer end thereof, and each first link 61 may have a pair of first inner lugs 61c fixed to the inner end thereof. The outer end of the second link 62 may be aligned with the inner ends of the first links 61 such that the second outer lugs 62c of the second link 62 may be aligned with the first inner lugs 61c of the first links 61. The pivot pin 67 may be inserted through the second outer lugs 62c of the second link 62 and the first inner lugs 61c of the first links 61 so that the first inner lugs 61c of the first links 61 may be pivotably connected to the second outer lugs 62c of the second link 62 through the pivot pin 67. Each first link 61 may include a first inner roller 65b adjacent to the first inner lug 61c, and the second link 62 may include a pair of second outer rollers 66b adjacent to the pair of second outer lugs 62c, respectively. The first inner rollers 65b and the second outer rollers 66b may be rotatably supported by the pivot pin 67. The pair of first links 61 may be spaced apart from each other by a distance corresponding to the width of the second link 62 so that the second link 62 may pass through a space between the pair of first links 61.

As described above, as the second step 50 moves relative to the first step 40, the outer ends of the pair of first links 61 may pivot relative to the first step 40 through the pivot pins 61b, the inner end of the second link 62 may pivot through the pivot pin 62b, and the inner ends of the pair of first links 61 and the outer end of the second link 62 may pivot through the pivot pin 67. The inner ends of the first links 61 may be spaced apart from the inner end of the second link 62, and the outer ends of the first links 61 may be spaced apart from the outer end of the second link 62.

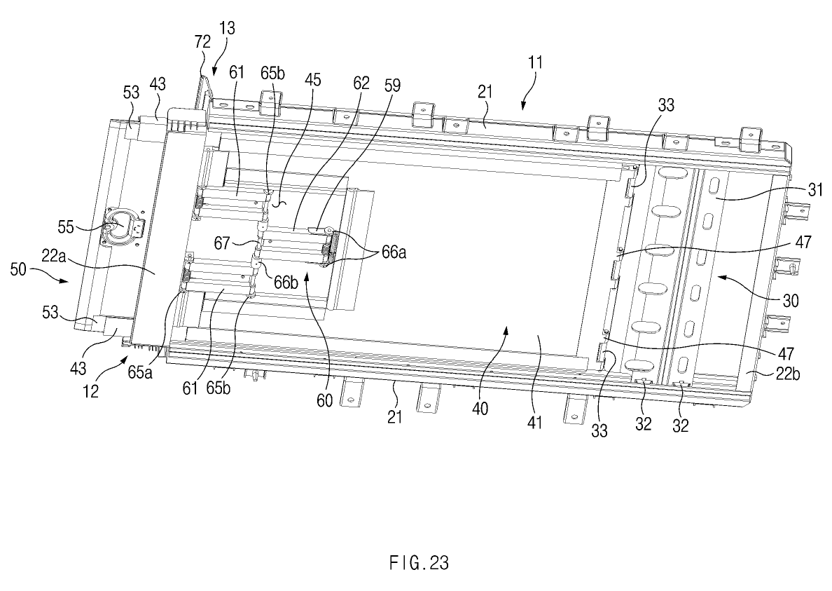

FIG. 23 illustrates a state in which the step assembly 12 is retracted in the storage space 11a of the housing 11, and the moving cover 72 of the cover assembly 13 is in the uncover position. Referring to FIG. 23, in a state in which the step assembly 12 is retracted in the storage space 11a of the housing 11, when the user intends to deploy the step assembly 12 from the storage space 11a of the housing 11, the user may move the moving cover 72 of the cover assembly 13 to the uncover position. Accordingly, the opening 11b of the housing 11 may be opened. The first links 61 and the second link 62 of the link mechanism 60 may be in the folded position in which they are folded against the second step 50 within the opening 45 of the first step 40.

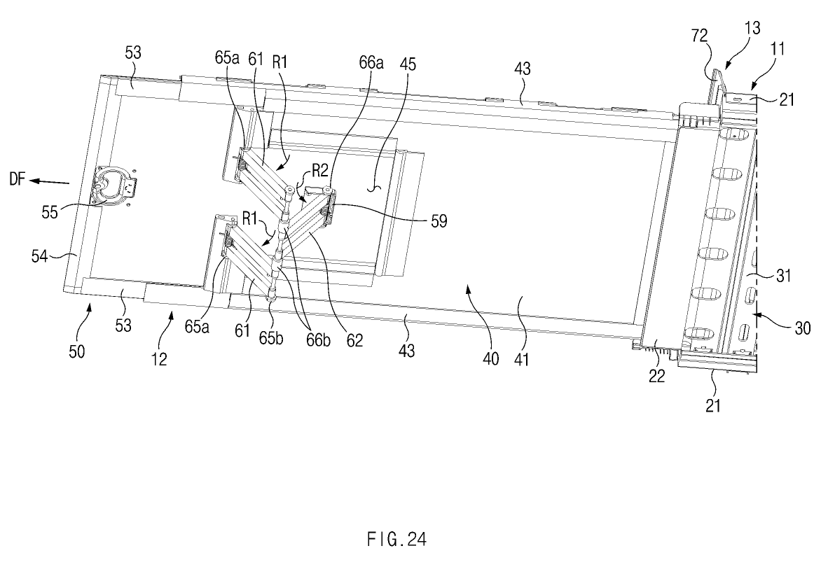

FIG. 24 illustrates an extension process in which the second step 50 is first extended from the first step 40 in an extension direction (see arrow DF), with the step assembly 12 fully deployed from the storage space 11a of the housing 11 and positioned outside the housing 11. Referring to FIG. 24, as the second step 50 is extended from the first step 40, the first links 61 of the link mechanism 60 may pivot to move to the unfolded position (see arrow R1), and the second link 62 may pivot to move to the unfolded position (see arrow R2). The first outer rollers 65a of the first links 61 and the second inner rollers 66a of the second link 62 may come into rolling contact with the second step 50, and the first inner rollers 65b of the first links 61 and the second outer rollers 66b of the second link 62 may come into rolling contact with the ground so that the second step 50 may be smoothly extended relative to the first step 40.

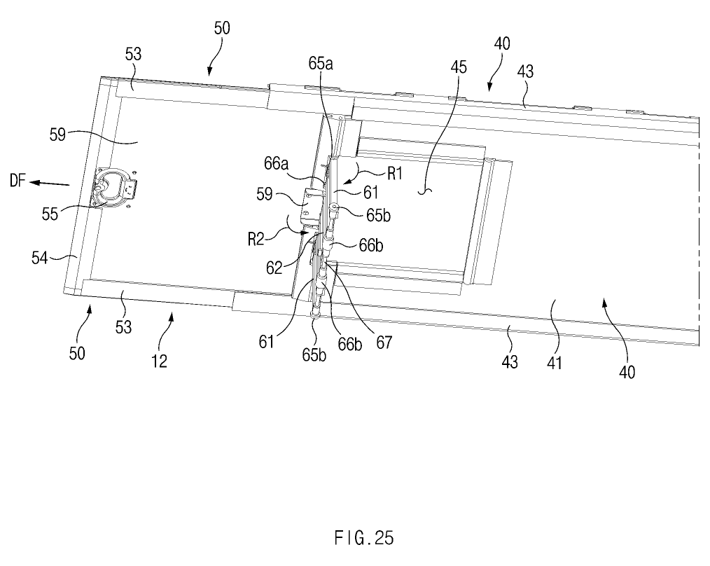

FIG. 25 illustrates an extension process in which the second link 62 passes through a space between the pair of first links 61 when the second step 50 is subsequently extended from the first step 40 in an extension direction (see arrow DF), with the step assembly 12 fully deployed from the storage space 11a of the housing 11 and positioned outside the housing 11. Referring to FIG. 25, as the second step 50 is extended from the first step 40, the first links 61 of the link mechanism 60 may pivot to move to the unfolded position (see arrow R1), and the second link 62 may pivot to move to the unfolded position (see arrow R2). The first outer rollers 65a of the first links 61 and the second inner rollers 66a of the second link 62 may come into rolling contact with the second step 50, and the first inner rollers 65b of the first links 61 and the second outer rollers 66b of the second link 62 may come into rolling contact with the ground so that the second step 50 may be smoothly extended relative to the first step 40.

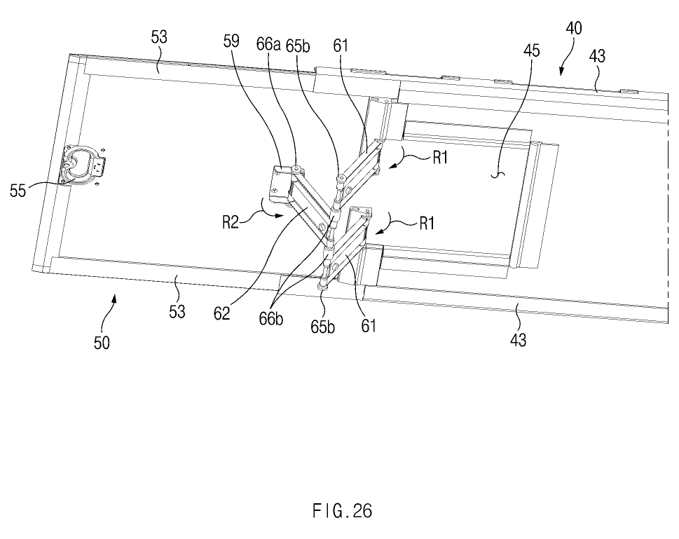

FIG. 26 illustrates an extension process in which the second step 50 is fully extended from the first step 40, with the step assembly 12 fully deployed from the storage space 11a of the housing 11 and positioned outside the housing 11. Referring to FIG. 26, as the first links 61 and the second link 62 of the link mechanism 60 are in the unfolded position, the first links 61 and the second link 62 may be supported on the ground, and the extended state of the second step 50 from the first step 40 may be stably maintained by the weights of the first step 40 and the second step 50.

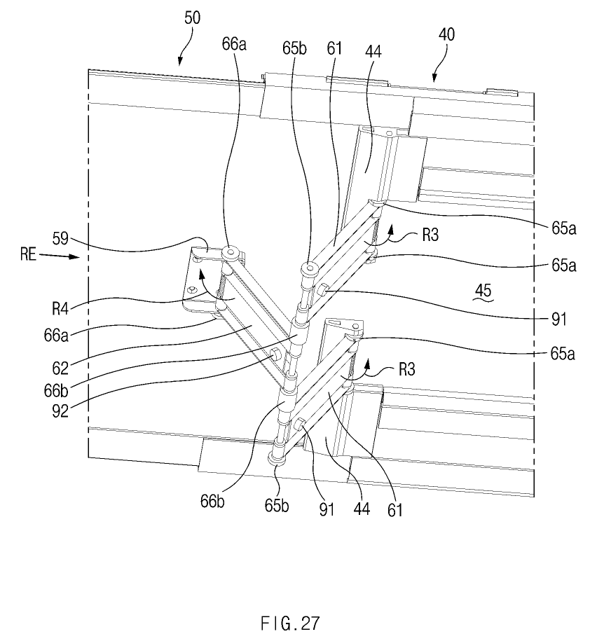

FIG. 27 illustrates a retraction process in which the second step 50 is retracted onto the first step 40, with the step assembly 12 positioned outside the housing 11. Referring to FIG. 27, as the second step 50 is retracted in a retraction direction (see arrow RE), the first links 61 of the link mechanism 60 may pivot to move to the folded position (see arrow R3), and the second link 62 may pivot to move to the folded position (see arrow R4). The first outer rollers 65a of the first links 61 and the second inner rollers 66a of the second link 62 may come into rolling contact with the second step 50, and the first inner rollers 65b of the first links 61 and the second outer rollers 66b of the second link 62 may come into rolling contact with the ground so that the second step 50 may be smoothly retracted relative to the first step 40.

Referring to FIGS. 19 and 27, each first link 61 may further include a first shock-absorbing member 91 attached to a rear surface thereof. As the first links 61 move to the folded position, the first shock-absorbing member 91 may absorb impact generated between the first links 61 and the second step 50. The second link 62 may further include a second shock-absorbing member 92 attached to a rear surface thereof. As the second link 62 moves to the folded position, the second shock-absorbing member 92 may absorb impact generated between the second link 62 and the second step 50.

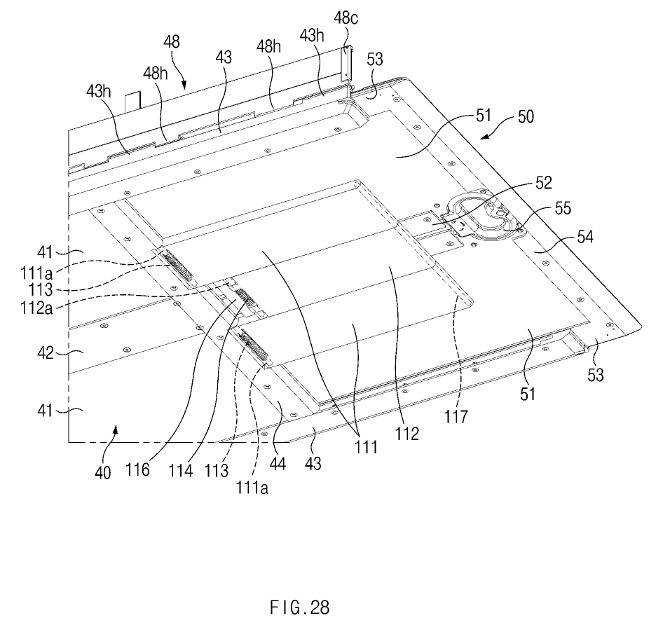

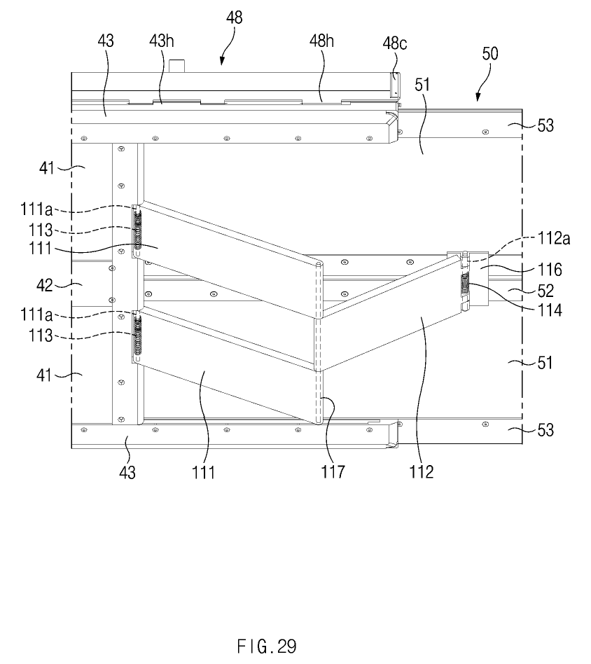

FIGS. 28 and 29 illustrate a ramp apparatus 100 for a vehicle according to another example embodiment of the present disclosure. Referring to FIGS. 28 and 29, a link mechanism 110 in the ramp apparatus 100 for a vehicle may be connected between the first step 40 and the second step 50 of the step assembly 12. The link mechanism 110 may include a pair of first links 111 pivotably connected to the first step 40, and a second link 112 pivotably connected to the second step 50. A length of the second link 112 may be less than that of each first link 111.

The pair of first links 111 may be pivotably connected to the outer cross member 44 of the first step 40, and each first link 111 may include an outer end facing the outside of the vehicle and an inner end facing the inside of the vehicle. The inner end of each first link 111 may be pivotably connected to the outer cross member 44 of the first step 40 through a pivot pin 111a.

Each first link 111 may be configured to move between a folded position in which the first link 111 is folded against the second step 50 and an unfolded position in which the first link 111 is unfolded from the second step 50 toward the ground. When each first link 111 is in the folded position, the first link 111 may be parallel to the first step 40 and the second step 50, and the first link 111 may contact the second step 50. When each first link 111 is in the unfolded position, the first link 111 may be inclined at an angle with respect to the second step 50.

The link mechanism 110 may further include a first biasing member 113 configured to bias each first link 111 toward the folded position. The first biasing member 113 may be a torsion spring mounted around the pivot pin 111a. Each first link 111 may be biased toward the folded position by the first biasing member 113.

The second link 112 may be pivotably connected to the second step 50, and the second link 112 may include an outer end facing the outside of the vehicle and an inner end facing the inside of the vehicle. The inner end of the second link 112 may be pivotably connected to the second center member 52 of the second step 50 through a pivot pin 112a. A mounting bracket 116 may be fixed to the second center member 52 of the second step 50, and the inner end of the second link 112 may be pivotably connected to the mounting bracket 116 through the pivot pin 112a.

The second link 112 may be configured to move between a folded position in which the second link 112 is folded against the second step 50 and an unfolded position in which the second link 112 is unfolded from the second step 50 toward the ground. When the second link 112 is in the folded position, the second link 112 may be parallel to the second step 50, and the second link 112 may contact the second step 50. When the second link 112 is in the unfolded position, the second link 112 may be inclined at a predetermined angle with respect to the second step 50.

The link mechanism 110 may further include a second biasing member 114 configured to bias the second link 112 toward the folded position. The second biasing member 114 may be a torsion spring mounted around the pivot pin 112a. The second link 112 may be biased toward the folded position by the second biasing member 114.

The outer end of the second link 112 may be aligned with the outer ends of the first links 111, and the outer end of the second link 112 may be pivotably connected to the outer ends of the first links 111 through a pivot pin 117.

Referring to FIG. 28, when the second step 50 is retracted onto the first step 40, the pair of first links 111 may be in the folded position, the second link 112 may be in the folded position, and the second link 112 may be overlapped between the pair of first links 111.

Referring to FIG. 29, when the second step 50 is extended from the first step 40, the pair of first links 111 may pivot to move to the unfolded position, and the second link 112 may pivot to move to the unfolded position.

According to the above-described example embodiments of the present disclosure, when the second step 50 is extended from the first step 40, the first links 61 or 111 of the link mechanism 60 or 110 may be unfolded from the second step 50 toward the ground, and the second link 62 or 112 of the link mechanism 60 or 110 may be unfolded from the second step 50 toward the ground. Accordingly, in a state in which the second step 50 is extended from the first step 40, the amount of sagging of the step assembly 12 may be reduced and the support stiffness of the step assembly 12 may be enhanced by the unfolded first links 61 or 111 and second link 62 or 112. Thus, the step assembly 12 may more firmly support a heavy load. When the second step 50 is retracted onto the first step 40, each first link 61 or 111 may be biased toward the folded position by a biasing force of the first biasing member 63 or 113, and the second link 62 or 112 may be biased toward the folded position by a biasing force of the second biasing member 64 or 114. Accordingly, the user may retract the second step 50 onto the first step 40 with a relatively smaller force.

As set forth above, according to example embodiments of the present disclosure, when the second step is extended from the first step, the first and second links of the link mechanism may be unfolded from the second step toward the ground. In a state in which the second step is extended from the first step, the amount of sagging of the step assembly may be reduced and the support stiffness of the step assembly may be enhanced by the unfolded first and second links, and thus the step assembly can more firmly support a heavy load. When the second step is retracted onto the first step, each first link may be biased toward the folded position by the first biasing member, and the second link may be biased toward the folded position by the second biasing member. Accordingly, the user may retract the second step onto the first step with a relatively smaller force.

According to example embodiments of the present disclosure, because the plurality of steps can be easily deployed from and retracted into the housing, the ramp apparatus may be easily applied to vehicles having a high step height, such as electric vehicles, and also to various vehicles having special structures.

According to example embodiments of the present disclosure, the ramp apparatus for a vehicle may have a compact structure, thereby being easily mounted at various positions of the vehicle, and improving passenger convenience.

According to example embodiments of the present disclosure, the ramp apparatus for a vehicle may be disposed on the bottom of the vehicle adjacent to the side opening so that a side-entry ramp system of the vehicle may be effectively implemented, thereby facilitating ingress and egress of passengers, and improving space utilization. In some embodiments, because the step assembly can be rapidly deployed from and retracted into the housing, passenger convenience may be further improved.

According to example embodiments of the present disclosure, the step assembly may be deployed from and retracted into the housing, and the second step may be extended from and retracted onto the first step so that the deployment length of the step assembly may be varied, and the angle of inclination of the step assembly may be varied.

According to example embodiments of the present disclosure, the first center member of the first step may be configured to guide the second center member of the second step, and the first side members of the first step may be configured to guide the second side members of the second step so that the step assembly may have a compact structure.

According to example embodiments of the present disclosure, the pair of first step plates of the first step may be connected between the first center member and the pair of first side members so that the first step may uniformly distribute a load. Likewise, the pair of second step plates of the second step may be connected between the second center member and the pair of second side members so that the second step may uniformly distribute a load.

Hereinabove, although the present disclosure has been described with reference to example embodiments and the accompanying drawings, the present disclosure is not necessarily limited thereto, and may be variously modified and altered by those skilled in the art to which the present disclosure pertains without departing from the spirit and scopes of the present disclosure claimed in the following claims and equivalents thereof.

What is claimed is:

1. A ramp apparatus for a vehicle, the ramp apparatus comprising:
a housing including a storage space and an opening communicating with the storage space;
a step assembly configured to be retracted into or deployed from the storage space of the housing, wherein the step assembly comprises a first step and a second step configured to move relative to the first step; and
a link mechanism pivotably coupled between the first step and the second step.

2. The ramp apparatus according to claim 1, wherein the link mechanism comprises:
a first link pivotably connected to the first step; and
a second link pivotably connected to the second step, wherein the second link is pivotably connected to the first link,
wherein the first link is configured to move between a folded position in which the first link is folded against the second step and an unfolded position in which the first link is unfolded from the second step.

3. The ramp apparatus according to claim 2, wherein the link mechanism further comprises a first biasing member configured to bias the first link toward the folded position.

4. The ramp apparatus according to claim 1, wherein the link mechanism comprises:
a first link pivotably connected to the first step; and
a second link pivotably connected to the second step, wherein the second link is pivotably connected to the first link,
wherein the second link is configured to move between a folded position in which the second link is folded against the second step and an unfolded position in which the second link is unfolded from the second step.

5. The ramp apparatus according to claim 4, wherein the link mechanism further comprises a second biasing member configured to bias the second link toward the folded position.

6. The ramp apparatus according to claim 1, wherein the link mechanism comprises:
a pair of first links pivotably connected to the first step; and
a second link pivotably connected to the second step,
wherein the second link is pivotably connected to the pair of first links,
wherein each of the pair of first links includes a first outer end facing an outside of the vehicle and a first inner end facing an inside of the vehicle,
wherein the second link includes a second outer end facing the outside of the vehicle and a second inner end facing the inside of the vehicle,
wherein the first outer end of each of the pair of first links is pivotably connected to the first step via a first pivot pin, and
wherein the second inner end of the second link is pivotably connected to the second step via a second pivot pin.

7. The ramp apparatus according to claim 6, wherein the second outer end of the second link is aligned with the first inner end of each of the pair of first links, and
wherein the second outer end of the second link is pivotably connected to the first inner end of each of the pair of first links via a third pivot pin.

8. The ramp apparatus according to claim 1, wherein the link mechanism comprises:
a pair of first links pivotably connected to the first step; and
a second link pivotably connected to the second step,
wherein the second link is pivotably connected to the pair of first links,
wherein each of the pair of first links includes a first outer end facing an outside of the vehicle and a first inner end facing an inside of the vehicle,
wherein the second link includes a second outer end facing the outside of the vehicle and a second inner end facing the inside of the vehicle,
wherein the first inner end of each of the pair of first links is pivotably connected to the first step via a first pivot pin, and
wherein the second inner end of the second link is pivotably connected to the second step via a second pivot pin.

9. The ramp apparatus according to claim 8, wherein the second outer end of the second link is aligned with the first outer end of each of the pair of first links, and
wherein the second outer end of the second link is pivotably connected to the first outer end of each of the pair of first links via a third pivot pin.

10. The ramp apparatus according to claim 1, wherein the step assembly further comprises a carriage pivotably connected to the first step, and
wherein the carriage is configured to move within the housing.

11. The ramp apparatus according to claim 1, further comprising a cover assembly mounted at the opening of the housing,
wherein the cover assembly comprises:
a fixed cover fixed to the housing, and
a moving cover pivotably connected to the fixed cover, and
wherein the moving cover is configured to move between a cover position in which the moving cover at least partially covers the opening of the housing and an uncover position in which the moving cover uncovers the opening of the housing.

12. The ramp apparatus according to claim 1, wherein the first step comprises:
a first center member extending along a first center line of the first step;
a pair of first side members extending along both side edges of the first step, respectively; and
a pair of first step plates connected between the first center member and the pair of first side members, and
wherein the first center member and the pair of first side members are configured to guide a movement of the second step.

13. The ramp apparatus according to claim 12, wherein the second step comprises:
a second center member extending along a second center line of the second step;
a pair of second side members extending along both side edges of the second step, respectively; and
a pair of second step plates connected between the second center member and the pair of second side members,
wherein the second center member is configured to be guided along the first center member, and
wherein the pair of second side members are configured to be guided along the pair of first side members.

14. The ramp apparatus according to claim 13, wherein the first center member includes a guide projection protruding toward the second center member,
wherein the second center member includes a guide groove in which the guide projection is received, with a configuration such that a movement of the second center member is guided by the guide projection and the guide groove.

15. The ramp apparatus according to claim 14, wherein the guide projection includes a first T-shaped cross section, and
wherein the guide groove includes a second T-shaped cross section corresponding to the first T-shaped cross section of the guide projection.

16. The ramp apparatus according to claim 13, wherein each of the first side members includes a cavity in which a corresponding one of the second side members is configured to be received, and
wherein the second side member is configured to move in the cavity of the first side member.

17. The ramp apparatus according to claim 1, wherein the link mechanism comprises:
a pair of first links pivotably connected to the first step; and
a second link pivotably connected to the second step, wherein the second link is pivotably connected to the pair of first links.

18. A ramp apparatus for a vehicle, the ramp apparatus comprising:
a housing including a storage space and an opening communicating with the storage space;
a step assembly configured to be translatably retracted into or deployed from the storage space of the housing, wherein the step assembly comprises a first step and a second step configured to translatably move relative to the first step; and
a link mechanism pivotably coupled between the second step to the first step,
wherein the link mechanism comprises:
a first link pivotably connected to the first step; and
a second link pivotably connected to the second step, wherein the second link is pivotably connected to the first link, in a configuration such that,
in a first movement, the link mechanism allows a first translating movement of the first step relative to the housing, and
in a second movement, the link mechanism allows a second translating movement of the second step relative to the first step.

19. The ramp apparatus according to claim 18, wherein the step assembly further comprises a carriage pivotably connected to the first step, and wherein the carriage is configured to move within the housing, such that the first step is configured to translate relative to the housing via the carriage and the first step is configured to pivot relative to the housing via the carriage based on the first step being deployed from the storage space of the housing.

20. A vehicle including a ramp apparatus, wherein the ramp apparatus comprises:
a housing including a storage space and an opening communicating with the storage space;
a step assembly configured to be retracted into or deployed from the storage space of the housing, wherein the step assembly comprises a first step and a second step configured to move relative to the first step; and
a link mechanism pivotably coupled between the first step and the second step.
